(19) United States
(12) Patent Application Publication
(10) Pub. No.: US 2023/0272709 A1
(43) Pub. Date: Aug. 31, 2023

(54) Choice of LCM Materials and Loading for Loss Circulation Control

(71) Applicant: Halliburton Energy Services, Inc., Houston, TX (US)

(72) Inventors: John Paul Bir SINGH, Houston, TX (US); Siva Rama Krishna JANDHYALA, Houston, TX (US); Ronnie Glenn MORGAN, Duncan, OK (US); KVVN Krishna Babu YERUBANDI, Houston, TX (US); Aleksey KOLASNIKOV, Houston, TX (US)

(21) Appl. No.: 17/680,552

(22) Filed: Feb. 25, 2022

(51) Int. Cl. E21B 49/00; C09K 8/516; E21B 47/10

(52) U.S. Cl. CPC E21B 49/005; C09K 8/516; E21B 47/10; E21B 2200/20

(57) ABSTRACT

A method of designing a fluid loss control treatment for a low pressure zone within a wellbore from drilling datasets indicative of drilling the wellbore. The design process can determine a fluid loss rate and a fracture location from the drilling dataset. The design process may determine a particle type to form an interface with a filter property at the fracture location by inputting a fracture geometry into a particle model. The filter property of the interface includes a porosity value, a permeability value, or combinations thereof that exceeds a threshold value. The design process may generate a fluid loss control treatment comprising a quantity of particles and a volume of carrier fluid for the fracture geometry within the wellbore.

### CROSS-REFERENCE TO RELATED APPLICATIONS

None.

### BACKGROUND

Hydrocarbon producing wells are typically formed by drilling a wellbore into a subterranean formation. A drilling fluid is circulated through a drill bit during the drilling operation as the wellbore is being drilled. The drilling fluid, also referred to as drilling mud, is circulated back to the surface of the wellbore with drilling cuttings for removal from the wellbore. The drilling fluid maintains a hydrostatic pressure within the wellbore to balance the formation pressure and permitting all or most of the drilling fluid to be circulated back to the surface. However, the hydrostatic pressure of the drilling fluid may be compromised if the drill bit encounters certain unfavorable subterranean zones, such as low pressure or high permeability zones caused by natural fissures, fractures, vugs, or caverns, for example. Similarly, if the drill bit encounters high-pressure zones or crossflows, for example, an underground blowout may occur. The compromised hydrostatic pressure of the drilling fluid from a low pressure zone causes a reduction of drilling fluid volume returning to the surface, termed “lost circulation.” The unfavorable subterranean zones contributing to lost circulation are termed “lost circulation zones.” In addition to drilling fluids, other operational treatment fluids, such as fracturing fluid, may be lost to the subterranean formation due to fluid loss. The term “lost circulation” refers to loss of a drilling fluid, while the term “fluid loss” is a more general term that refers to the loss of any type of fluid into the formation. As a result, the service provided by the treatment fluid is often more difficult to achieve or suboptimal.

The consequences of lost circulation or fluid loss can be detrimental, ranging from minor volume loss of treatment fluids, to delayed drilling and production operations, to wellbore stability issues resulting in an underground collapse. Therefore, the occurrence of fluid loss during hydrocarbon well operations typically requires immediate remedial steps. Remediation often involves introducing a composition into the wellbore to seal unfavorable subterranean zones and prevent leak off of treatment fluids within the formation to the unfavorable zones. Such compositions are generally referred to as fluid loss control treatments or loss control materials (LCM).

In fluid loss control treatments, the composition can include a LCM particle and a carrier fluid to suspend and transport the LCM particle to the target location, e.g., lost circulation zone. The type of LCM material can be selected based on the formation type, specific to an oil field, or specified by a customer. The fluid properties, such as density, of the carrier fluid may be tailored to the specific gravity of the LCM particle. The compatibility of the carrier fluid to the formation properties may limit the fluid properties of the carrier fluid. The effectiveness of the fluid loss control treatment can depend on selecting an effective LCM treatment based on the type of low pressure zone. A method of designing a well treatment with a LCM particle and carrier fluid compatible with the type of low pressure zone is desirable.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a cut-away illustration of a drilling operation according to an embodiment of the disclosure.

FIG. 2 is a block diagram of a communication system according to an embodiment of the disclosure.

FIG. 3 is a cross-sectional view of a low pressure zone within a subterranean formation according to an embodiment of the disclosure.

FIG. 4 is a logical flow diagram of a method to design a fluid loss treatment according to an embodiment of the disclosure.

FIGS. 5A and 5B illustrate a geometric shape of a natural fracture according to an embodiment of the disclosure.

FIGS. 6A and 6B illustrate a geometric shape of an induced fracture according to an embodiment of the disclosure.

FIG. 7 illustrates another geometric shape of an induced fracture according to an embodiment of the disclosure.

FIG. 8 is a logical flow diagram depicting a method to generate a design of a fluid loss treatment from historical well data according to an embodiment of the disclosure.

FIG. 9 is a logical flow diagram depicting a method to generate a design of a fluid loss treatment during a wellbore servicing operation according to an embodiment of the disclosure.

FIG. 10 is a block diagram of a computer system suitable for implementing one or more embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The present disclosure relates to wellbore servicing and methods to design a wellbore service for operation in the presence of fluid loss, including the volumes, rates, and duration of pumping of fluids in the presence of fluid losses. While the present techniques may be particularly suited for wellbore cementing and design of corresponding spacer fluids and cement compositions, embodiments can be used to design any of a variety of fluids used in wellbore servicing, including cement compositions, spacer fluids, drilling fluids, wellbore flushes, and displacement fluids, among others. The fluid design includes composition and properties, such as water-to-solids ratio, fluid loss, free water, pumping time, pumping rate, density, and rheology, as well as fluid volume for the wellbore service. As disclosed herein, rheology may be defined as, but may not be limited to, a mathematical function that correlates shear stress to shear rate.

As used herein, the terms “casing,” “casing string,” “casing joint,” and similar terms refer to a substantially tubular protective lining for a wellbore. Casing can be made of any material, and can include tubulars known to those skilled in the art as casing, liner, and tubing. In certain embodiments, casing may be constructed out of steel. Casing can be expanded downhole, interconnected downhole and/or formed downhole in some cases.

As used herein, the terms “drill pipe,” “drill string,” “drill pipe joint,” and similar terms refer to a substantially tubular member that conveys a component such as a drill bit from surface into the wellbore. Drill pipe can be made of any material, and can include tubulars known to those skilled in the art as drill pipe, drill collars, heavy-weight tubing, work-over pipe, and coil tubing. In certain embodiments, drill pipe may be constructed out of steel.

As used herein, the term “downhole surface” and similar terms refer to any surface in the wellbore or subterranean formation. For example, downhole surfaces may include, but are not limited to a wellbore wall, an inner tubing string wall such as a casing wall, a wall of an open-hole wellbore, and the like.

An oil well can be drilled with a drill bit and mud system. A suitable drilling rig can be located on a drilling pad onshore or offshore above the drilling location. As the drill bit penetrates the earth strata, a drilling mud is pumped down a drill string to bring cuttings back to surface. The drilling mud can be water based or oil based with a clay material to increase the weight of the fluid. The drilling mud may also contain various other chemicals for compatibility with the wellbore and to enhance the ability to return cuttings to surface. As previously stated, the weight of the drilling fluids can retain the desired hydrocarbons in the formation until the well is completed. However, a loss circulation zone can remove a volume of drilling fluids and subsequently reduce the amount of drilling fluid returning to surface.

The present disclosure relates to fluid loss materials comprising LCM particles and fluid systems in the oil and gas industry. Particularly, the present disclosure relates to a design process for identifying an LCM particle and a fluid system for conveying the LCM particle to the low pressure zone. The present disclosure implements a model-based methods and systems for determining the effect of the LCM particle on the fluid loss rate, in accordance with one or more embodiments. For example, this method may enable wellbore fluid design based on predicted wellbore porosity at a targeted location, e.g., lost circulation zone. The particle model disclosed herein may generate a porosity of the low pressure zone based on the type of particle, the concentration of particles, the carrier fluid, and the geometry of the low pressure zone. The input of the geometry of the low pressure zone may be an output of a fracture model. In one or more embodiments, the type of fracture, e.g., geometry of the low pressure zone, may be determined by a fracture model. The input of the type of particle may depend on the available inventory of particles. In one or more embodiments, the input of the particle type into the particle model may depend on the inventory of particle types at a wellsite. In another scenario, the inventory of the types of particles transported to the wellsite may depend on the particle model during the design of the fluid loss control treatment. For example, the particle model may generate at least one particle and carrier fluid combination for a predicted type of fluid loss zone. Hence, the fluid loss treatment may be coupled to the predicted type of fluid loss zone for a given wellsite to achieve a desired fluid function, such as effective circulation of fluids and placement of wellbore treatment fluids

The particle model disclosed herein considers a number of factors that contribute to lost circulation or fluid loss. As disclosed herein, the particle model is defined as a mathematical model that calculates the porosity and the permeability of the low pressure zone as a function of particle size, shape of the particles, concentration of the particles, thickness of the deposited particles as a function of time, carrier fluid rheology, and formation properties, such as, but not limited to, permeability, porosity, flow resistance as a function of time, pore throats, fracture size and width (induced or natural). In example embodiments, the particle model disclosed herein utilizes an estimated porosity of the low pressure zone, particle size, particle shape, distribution of particles at the low pressure zone, or combinations thereof to generate a permeability of a surface interface at the low pressure zone. In addition, the particle model may further utilize fluid characteristics, such as fluid rheology and density.

One of the inputs to the particle model may include the output of a type of loss mechanism from a fracture model. The present disclosure may utilize a model-based method for determining the geometry, e.g., the loss mechanism, of the low pressure zone. In some embodiments, the fracture model is defined as a mathematical model that determines the probability of a type of loss mechanism based on the fluid loss rate, the density and rheology of the fluid, the wellbore geometry and trajectory, and an output from a wellbore hydraulics model. The fracture model may model the fracture geometry with multiple equations sets to simulate different fracture types, for example, naturally occurring fractures. The fracture model may output a probability of each type of fracture geometry. In some embodiments, the fracture model may include drilling datasets from offset wells. The drilling datasets may include formation location, e.g., depth and duration, of one or more formation types. The drilling datasets may also include low pressure formation information comprising location, e.g., depth and duration, and type of fracture, e.g., fracture geometry.

One of the inputs of the fracture model may include the output of a wellbore hydraulics model. The present disclosure may utilize a model-based method of determining the fluid flowrates, wellbore stability, and equivalent circulating density (ECD) of the servicing fluids. The inputs to the wellbore hydraulics model can include wellbore geometry and trajectory, fluid density and rheology, formation properties (including pore pressure, thermal properties, geothermal temperature), and specific gravity of solid particles. In some embodiments, the wellbore hydraulics model may be a drilling fluids model. The drilling fluids model may include the drill string geometry, e.g., the outside diameter, with the wellbore geometry to determine the annular volume and annular flowrates. The drilling fluid density, rheology, thermal properties, and particle size may be inputs into the drilling fluids model. The drilling fluids model may determine a circulating pressure, fluid loss rate, a hole cleaning efficiency, a location of a low pressure zone, or combinations thereof. In some embodiments, the wellbore hydraulics model may be a circulating model also called a cementing fluids model. The inputs to the circulating model can include a casing string and downhole cementing equipment, e.g., float shoe, to determine an annular volume and annular flowrates. The circulating fluids model can include a drilling fluid density and rheology, a spacer fluid density and rheology, various other types of fluids, density, and rheology, a particle type and concentration, or combinations thereof. The circulating model may account for various fluid types and volumes to determine the pump rates, pumping time, and overall volume pumped. In some embodiments, the output of the circulating model can be a pumping schedule also referred to as a pumping procedure.

In some embodiments, the design process for identifying an LCM particle and a fluid system can include the wellbore hydraulics model, the fracture model, and the particle model. The wellbore hydraulics model may determine a loss mechanism based on the inputs into a mathematical model. The inputs may include the wellbore geometry, fluid rheology, fluid loss rate, or combinations thereof. The fracture model may determine the fracture geometry based on the inputs into a mathematical model. The inputs may include the loss mechanism from the wellbore hydraulics model. The particle model may determine a type of particle, a shape of particle, a concentration of particles, a porosity of the interface surface, a permeability of the interface surface, or combinations thereof.

In some embodiments, the design process may determine one or more LCM particles and fluid systems to transport to a wellsite. The design process may utilize a historical database of existing wellsites within the same oil field or that transverse the same subterranean formation. The design process may analyze a drilling dataset with the wellbore hydraulics model to determine a fluid loss mechanism. The fluid density and rheology, wellbore geometry and trajectory, and formation properties may be inputs into the wellbore hydraulics model. The fracture model may determine the geometry of the fracture at the low pressure zone. The fluid loss mechanism from the wellbore hydraulics model may be included in the inputs to the fracture model. The particle model may predict a resultant porosity based on the particle type and concentration for a fracture geometry at the low pressure zone. The geometry of the fracture may be one of the inputs into the particle model. The particle model may output one or more particles for the low pressure zone. A wellbore may include two or more low pressure zones along the wellbore path. The design process may determine at least one particle for each low pressure zone. The design process may output multiple particles for transport to the wellsite to provide wellbore fluid control along the entire wellbore path.

In some embodiments, the design process may determine at least one LCM particle and fluid system for use at the wellsite. The design process may determine a fluid loss control treatment to match a fracture geometry at the wellsite. A wellbore servicing operation may transport at least two fluid loss control treatments to the wellsite. The design process may receive operational datasets indicative of a pumping operation. The design process may process the operational datasets to determine a fluid loss mechanism utilizing the wellbore hydraulics model. The design process may determine the geometry of a fracture at a low pressure zone using the loss mechanism as an input. The design process may determine a probability of a porosity at the low pressure zone with the particle model utilizing the geometry of the fracture as one of the inputs. The design process may recommend at least one particle from a selection of two or more particles based on the probability of the resultant porosity. The wellbore servicing operation may deliver the fluid loss control treatment via a pumping operation to the low pressure zone.

Disclosed herein is a method of designing an fluid loss control treatment based on a wellbore hydraulic model, a fracture model, and a particle model. The design process can determine a fluid loss mechanism from drilling operation datasets. The design process can determine the geometry of a fracture with a fracture model based on fluid loss mechanism. The design process can determine a fluid loss treatment based on the geometry of the fracture. The recommended fluid loss treatment can be updated with real-time service operation datasets.

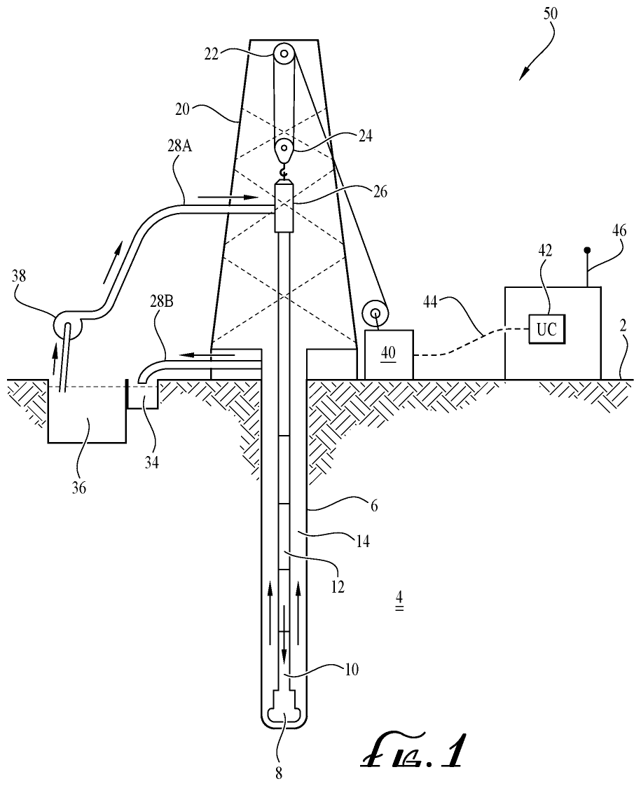

Turning now to FIG. 1, illustrated is a wellbore drilling environment 50 that can be utilized to monitor the drilling of a wellbore. In some embodiments, the wellbore 6 can be drilled into the subterranean formation 4 using a drilling system utilizing any suitable drilling technique and can extend in a substantially vertical direction away from the earth's surface 2. At some point in the wellbore 6, the vertical wellbore portion can transition into a substantially horizontal wellbore portion. The drilling system can include a drill bit 8 and a bottom hole assembly (BHA) 10 mechanically coupled to a drill string 12. The drill string 12 generally comprises an inner bore for the transfer of drilling fluids to the drill bit 8. The drilling fluids, e.g., drilling mud, can cool and lubricate the drill bit 8 and lift drill cuttings to the surface along the annulus 14 between the drill string 12 and wellbore 6.

The drilling system can include a drilling rig 20 comprising a lifting mechanism, a fluid system, and a rotation mechanism. The lifting mechanism can comprise a crown block 22, a traveling block 24, and a draw-works 40 and may be described as a block and tackle system releasably connected to the drill string 12, BHA 10, drill bit 8, or combinations thereof. A draw-works 40 can provide the mechanical force, via a drill line, to raise and lower the traveling block 24. The operation of the lifting mechanism can be controlled by a unit controller, e.g., unit controller 42. The lifting mechanism may include a plurality of sensors such as block height sensor, block speed sensor, hook load sensor, and weight indicator that provide feedback to the unit controller 42. The datasets provided by the plurality of sensors from the lifting mechanism may be included in a drilling dataset.

The drilling system can comprise a fluid system to transport drill cuttings to surface. The fluid system can comprise a return line 28B, a shale shaker 34, a mud tank 36, a suction line, a mud pump 38, a stand pipe 28A, and a swivel 26. The fluid system provides a fluid circuit to transport drill cuttings to surface, separate the cuttings, and circulate clean drilling mud back to the drill bit 8. The mud pump 38 can provide the flowrate and pressure of the drilling fluids via the inner bore of the drill string 12 to the drill bit 8. The mud density and rheology can be monitored and modified via the mud tank 36. The shale shaker 34 receives the drilling fluid, via the return line 28B, separates the drill cuttings from the drilling mud, and returns the drilling mud to the mud tank 36 to cool. The fluid system may include a wellhead, blowout preventer, and bell nipple for pressure control of the wellbore environment. The operation of the fluid system may be controlled via a control unit, e.g., unit controller 42. The fluid system may include a plurality of sensors such as flowrate sensors, pressure sensors, tank volume sensors, and sensors to determine drilling fluid properties such as density and rheology that provide feedback to the control unit. The datasets provided by the plurality of sensors from the fluid system may be included in a drilling dataset.

In some embodiments, the measurements of the fluid system can be provided by a daily drilling log, a mud report, or combinations thereof. A daily drilling log, also referred to as a daily drilling report, comprises a wellsite description, a drilling progress report, a drilling mud report, casing, and drill bit. The wellsite description can include a unique identification for the wellbore including a well name, a geographic location, a location within an oil field, a lease identification, a spud date, or combinations thereof. The drilling progress report may include a time period on location, a measure depth, a true vertical depth (TVD), a 24 hour footage, a number of hours drilling, and current drilling operations. The drilling mud report may comprise density, rheology, fluid loss, chemical properties, and solids control. The density reported in the mud report can include a mud weight in (density of drilling fluid pumped into the drill string) and mud weight out (density of drilling fluid exiting the wellbore). The rheology reported in the mud report can include funnel viscosity (basic measure of viscosity), plastic viscosity (viscosity of drilling fluids in motion), yield point (minimum shear stress for flow), and various gel strength measurements. The fluid loss recorded in the mud report determines the loss of fluid to the formation based on the hydrostatic pressure maintenance. The fluid loss report comprises a filtrate volume (volume of mud filtrate), cake thickness, a high-pressure, high temperature filtration test (static filtration at elevated temperatures), and water loss (volume of liquid measured in the filtration tests). The chemical properties of the drilling fluid can be measured and recorded to determine if the physical properties are changing or if the drilling fluid is eroding the wellbore 6. The solid control can determine the portion of low-gravity solids, high-gravity solids, percent of water, percent of oil, and percent of solids in the drilling fluid. A mud logging report may also include measurements of entrained gas within the drilling fluid and/or drilling fluid system. The datasets provided by the daily drilling log, the mud log, or combinations thereof may be provided to the service operation at the wellsite. In some embodiments, the daily drilling log, the mud log, the mud logging report, can be included in a drilling dataset.

The drilling rig 20 can comprise a rotation mechanism for rotating the drill string 12. The rotational mechanism for the drilling rig 20 can include a kelly 32, a kelly bushing, and a rotary table. The rotary table can mechanically couple the kelly 32 with the kelly bushing to the rig structure to provide rotation to the drill string 12. In some embodiments, the rotational motion mechanism of the drilling rig 20 can include a top drive device to provide mechanical rotation of the drill string 12. The operation of the rotation mechanism may be controlled via a control unit, e.g. unit controller 42. The rotation mechanism can include sensors such as torque sensor and rotary speed sensor that provide feedback to the unit controller. The datasets provided by the plurality of sensors of the rotation mechanism may be included in a drilling dataset.

The drilling rig 20 can include a BHA 10 mechanically connected to the drill string 12. The BHA 10 can include a rotary steerable assembly to control the direction of drilling such as an Measurements-While-Drilling (MWD) and/or Logging-While-Drilling (LWD) assembly. The rotary steerable assembly of the BHA 10 can measure wellbore properties, drilling parameters, and direction measurements with various sensors. The BHA 10 can communicate sensor measurements by mud-pulse technology via the fluid system of the drilling system. The datasets provided by the BHA 10 may be included in a drilling dataset.

The wellbore drilling environment 50 may include surface equipment for the control and monitoring of the drilling process. The drilling system can include a unit controller 42 comprising a processor, a non-transitory memory, and a communication device 46. The unit controller 42 can be communicatively connected to the drilling system via wired cable 44 or a wireless communication method, e.g., WIFI. The unit controller 42 can direct the drilling via drilling personnel, e.g., the driller, or may automate a portion of the drilling process via wired or wireless communication. A plurality of sensors for the lifting mechanism, the fluid system, the rotation mechanism, and the wellhead can provide feedback to the unit controller 42 via a data acquisition (DAQ) unit. The communication device 46 can communicatively connect the unit controller 42 to one or more remote user devices as will be disclosed herein after.

In some embodiments, the drilling operation can include lowering a casing string into the wellbore 6. The casing string can comprise various primary cementing equipment such as a float shoe, a float collar, and a plurality of centralizers. The drilling rig 20 can convey a casing string into the wellbore 6 via the lifting mechanism. This operation can be referred to as a cementing operation comprising lowering the casing string while circulating fluids at various intervals. For example, the cementing operation may lower a predetermined length of casing, e.g., 1,000 ft of casing, into the wellbore 6, fluidically connect the fluid system to the casing string, and circulate a predetermined volume of fluid down the casing string and back to surface. The cementing operation can convey the casing string to the bottom of the wellbore 6 and circulate a predetermined volume of fluid in preparation of pumping cement or other cementitious slurry. The predetermined volume of fluid may be pumped down the casing string, out the float shoe, and return to surface via an annular space between the outer surface of the casing string and the inner surface of the wellbore 6.

The data gathered by the sensors on the drilling system can include stress, strain, flow rate, fluid properties (density and rheology), fluid pressure, temperature, and acoustic data. The fluid sensors can include a communication method for the BHA 10. The unit controller 42 can communicate with the BHA 10 via the fluid system. The BHA 10 can transmit datasets of directional data, wellbore environment, and drilling parameters to the unit controller 42 via the fluid system.

Although the wellbore drilling environment 50 is illustrated as a wellsite on land, it is understood that the wellbore drilling environment 50 can be offshore. The wellhead can be mechanically coupled to surface casing to anchor the wellhead and blowout preventer at surface 2. The wellhead can include any type of pressure containment equipment connected to the top of a casing string, such as a surface tree, production tree, subsea tree, lubricator connector, blowout preventer, or combination thereof. The wellhead can be located on a production platform, a subsea location, a floating platform, or other structure that supports operations in the wellbore 6. In some cases, such as in an off-shore location, the wellhead may be located on the sea floor while the drilling rig 20 can be located on a structure supported by piers extending downwards to a seabed or supported by columns sitting on hulls and/or pontoons that are ballasted below the water surface, which can be referred to as a semi-submersible platform or floating rig.

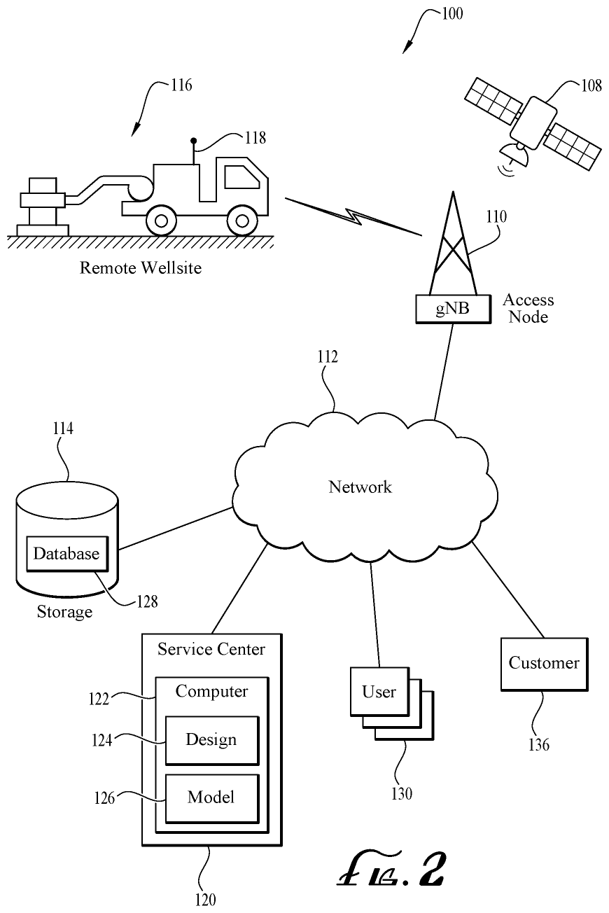

Turning now to FIG. 2, a communication system 100 is described. The communication system 100 comprises a remote wellsite 116, a cellular site 110, a network 112, a storage computer 114, a computer system 122, a plurality of user devices 130, and a customer device 136. A remote wellsite 116 with a communication device 118 (e.g., communication device 46 of FIG. 1) can transmit via any suitable communication means (wired or wireless), for example wirelessly connect to a cellular site 110 to transmit data to a storage computer 114. The cellular site 110 can be communicatively connected to a network 112 that can include a 5G network, one or more public networks, one or more private networks, or a combination thereof. A portion of the internet can be included in the network 112. The storage computer 114 can be communicatively connected to the network 112. The service center 120 can have one or more servers and/or computer systems 122. A design process 124 can be executing on a computer system 122 in the service center 120.

A communication device 118 on a remote wellsite 116 can transmit data collected from the equipment sensors, wellhead sensors, and/or BHA 10 to the storage computer 114. The communication device 118 can comprise a storage device and a data transmission device. The communication device 118 can wirelessly connect to the cellular site 110 continuously or at a predetermined schedule. In some embodiments, the communication device 118 can connect or attempt connection to the storage computer 114 via the cellular site 110 based on an established schedule. In some embodiments, the design process 124 can request the data from the communication device 118 based on an established schedule. The storage computer 114 can connect or attempt connection to the communication device 118 via cellular site 110 based on an established schedule. The communication device 118 can wirelessly connect to the network 112 via satellite communication 108.

The storage computer 114 can include a historical database 128 of datasets from remote drilling operations. A remote wellsite 116 can transmit one or more datasets indicative of a drilling operation. For example, the historical database 128 may comprise a plurality of datasets from wellbore drilling operations at remote wellsites, e.g., 116. The plurality of datasets within the historical database 128 may comprise one or more remote wellsites within the same field as will be described further herein.

A user device 130 can transfer a drilling dataset from the storage computer 114 to a design process 124 executing on a computer system 122 in the service center 120. The drilling dataset can include the drilling system data and fluid system data collected from remote wellsite 116 over a designated time period. The drilling dataset can include multiple types of datasets from a complete drilling operation. Alternatively, a drilling dataset from the storage computer 114 can be transferred automatically or via a scheduler to a design process 124. The design process 124 can process the drilling dataset indicative to the drilling operation of the remote wellsite 116. The user device 130 can receive customer inputs from a customer device 136. The user device 130 can transmit the customer inputs and at least one dataset from the historical database 128 to the design process 124. The design process 124 may access one or more models 126 during a design process determine a fluid loss control treatment, an additional fluid loss control treatment, changes to a design of a fluid loss control treatment, changes to the drilling fluid, a treatment fluid, or combinations thereof from analysis of the drilling dataset.

A remote wellsite 116 may transmit a periodic dataset indicative of a current drilling operation to the design process 124. The design process 124 may determine a fluid loss control treatment, an additional fluid loss control treatment, changes to a design of a fluid loss control treatment, changes to the drilling fluid, a treatment fluid, or combinations thereof based on one or more periodic datasets received from the remote wellsite 116 via the communication device 118.

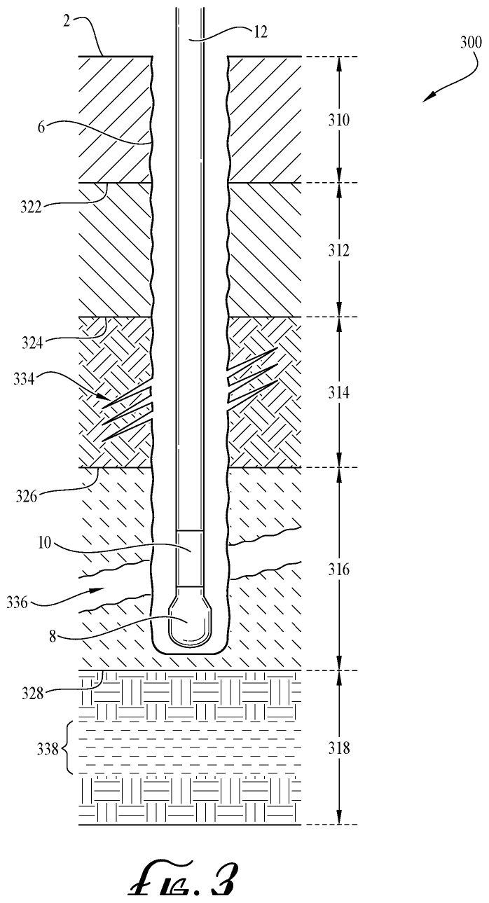

The drilling operation of FIG. 1 may encounter multiple types of subterranean formations during the progress of the drilling of the wellbore 6. Turning now to FIG. 3, an cross-sectional view of a low pressure zone that can be encountered during a drilling operation is illustrated. In some embodiments, the path of the wellbore 6 can traverse multiple types of subterranean formations. As illustrated, the wellbore 6 traverse subterranean formations 310, 312, 314, 316, and 318. The geological properties of each formation, such as mineralogy, can change. An interface, called a formation top, can be located between formations. For example, formation top 322 may be located between subterranean formation 310 and subterranean formation 312. Formation top 324 can be located between subterranean formation 312 and 314. Formation top 326 can be located between subterranean formation 314 and 316. Formation top 328 can be located between subterranean formation 316 and 318. A formation can include a low pressure or high permeability zone in the form of one of three types of fractures: a natural fracture, an induced fracture, or a highly permeable zone. Natural fractures, for example fracture 334 in subterranean formation 314, are openings which exists underground due to multiple reasons and may traverse the wellbore causing fluid loss. The natural fractures could be related, for example, to geomechanics (plate tectonics) or due to underground dissolution/erosion. Induced fractures, for example fracture 336 in formation 316, are fractures traversing the wellbores that are induced by wellbore operations that include but not limited to: wellbore hydraulic friction combined with hydrostatic pressure exceeding the fracture gradient of the reservoir; wellbore pressure spikes that occur during startups after drilling and/or circulation has been stopped; and the like. Highly permeable zones, for example fracture 338 in formation 318, are formation zones traversed by the wellbore that are susceptible to loss of fluid. Typically, the determination of loss mechanism is based on the prior experience in the field coupled with the knowledge of the rock type in a formation. For example, carbonate-based rocks such as limestone are prone to react with underground water and form natural opening (fractures). Weak sandstone and depleted reservoirs may be prone to induced fracture. Depleted reservoir might also be highly permeable zones.

Turning now to FIG. 4, a method 400 of designing a fluid loss control treatment is illustrated as a logic block diagram. The design process 124 of FIG. 3 comprises at least one model 126 to determine the fluid loss control treatment for a low pressure zone, e.g., first fracture 334 of FIG. 3. The design process 124 may include a wellbore hydraulics model, a formation fracture model, and a particle model. The design process 124 may generate the fluid loss control treatment of the low pressure zone, e.g., fracture 334, with the results of at least one model 126, e.g., the particle model.

In some embodiments, the method 400 comprises the following steps executing in a design process 124. At step 410, the design process 124 can of FIG. 2 can deliver input values 412 to the model 414, e.g., the wellbore hydraulics model, to determine the fluid loss mechanism of a low pressure zone, e.g., fracture 334 of FIG. 3, within a formation, e.g., formation 314. The design process 124 can retrieve a plurality of datasets from the remote storage of communication device 118 on the remote wellsite 116. The datasets can include fluid loss rates, treatment fluid properties, e.g., density and rheology, wellbore geometry and trajectory, formation properties, or combinations thereof. The design process 124 can input the datasets as input values 412 into one or more models 126, for example, the wellbore hydraulics model 414. The wellbore hydraulics model 414 can determine output values 416 comprising a fluid loss mechanism, a fluid loss rate, a fluid rheology, a wellbore geometry and trajectory, formation properties, or combinations thereof for at least one low pressure zone, e.g., formation 314, within the wellbore 6.

At step 420, the input values 422 of the second model, e.g., model 424, can include the output values 416 of the first model, e.g., model 414. The design process 124 can transfer the output values 416 from the wellbore hydraulics model 414 to the formation fracture model 424 as input values 422. The input values 422 may include the fluid loss mechanism, a differential pressure, fluid density and rheology, and the material properties of the formation, e.g., formation 314. The formation fracture model 424 can determine a probability of the fracture, e.g., fracture 334 of formation 314, being one of three types of fractures: a natural fracture, an induced fracture, or a highly permeable zone. The formation fracture model 424 can calculate the loss rate based on mathematical models of each type of fracture and generate a probability of the fluid loss rate being a resultant of each type of fracture.

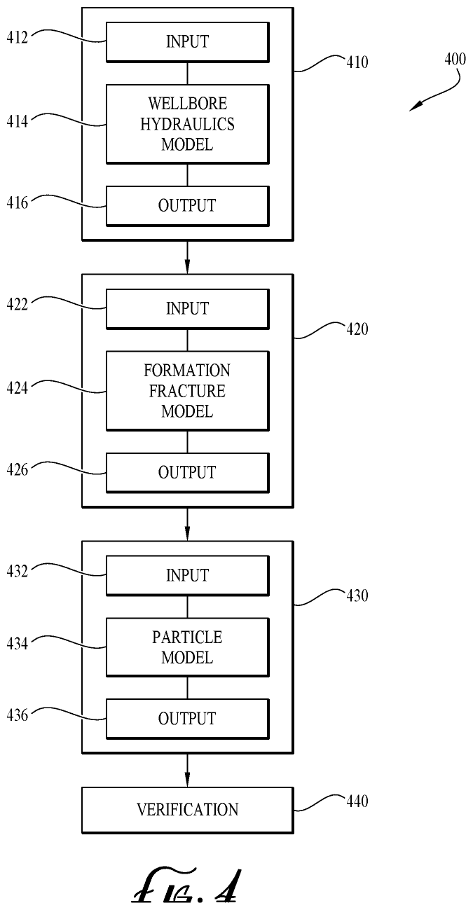

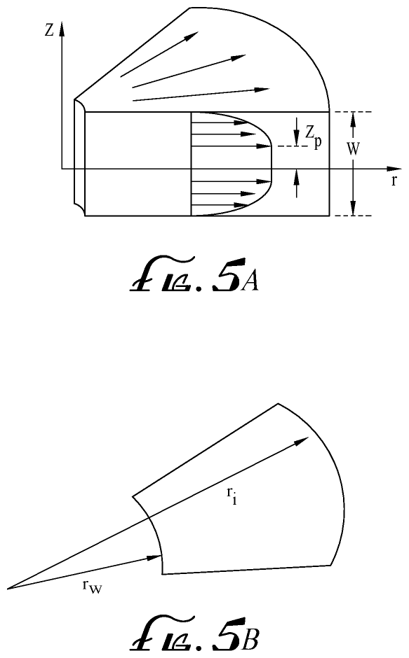

The formation fracture model 424 can determine the fracture is a natural fracture based on the loss rate using an equation that represents a disc, but may include, but not limited to: narrow slits; irregular fractures; a network of pipes, e.g., pipe network; and the like. FIGS. 5A and 5B illustrates an assumed geometric shape of natural fractures, e.g., fracture 334 in formation 314, that may be encountered in a wellbore 6. As discussed above, a wellbore treatment fluid may be lost into the natural fractures. In FIG. 5A, the width of the fracture is illustrated by width, w, and the depth of the opening in the radial direction is illustrated by radius, r. Also illustrated on FIG. 5A are the z-axis of the wellbore and the plug flow region Zₚ of fluid loss into the fracture In FIG. 5B, rᵢ is the depth of the opening in the radial direction while r_{w} is the radius of the wellbore.

Below is an example equation that may be used to determine the loss rate (\dot{Q}) for natural fractures:

\dot{Q}=f(differential pressure,fracture characteristics,rheology) Equation 1

Below is another example equation that may be used to determine the loss rate (\dot{Q}) specifically for the disc-shaped geometry:

$$\dot{Q} = \frac{\begin{matrix}{[ Δ p - ( \frac{2 m + 1}{m + 1} ) ( \frac{2 τ y}{w} ) ( {r}_{i} - {r}_{w} ) ]}^{\frac{1}{m}} \\ {[ ( 1 - m ) ( \frac{w}{2} ) ]}^{\frac{1}{m}} [ \frac{4 π m}{2 m + 1} {( \frac{w}{2} )}^{2} ]\end{matrix}}{{[ k ( {r}_{i}^{1 - m} - {r}_{w}^{1 - m} ) ]}^{\frac{1}{m}}} \qquad Equation 2$$

$$wherein τ = {τ}_{y} + k {\dot{γ}}^{m} \qquad Equation 3$$

wherein Δp is differential pressure between the fracture opening at the wellbore 6 and the far end of the fracture which will be at the pore pressure; τ_{y} is the fluid's yield stress; w is the height of the loss zone along the wellbore (or the width of the fracture); m is the power law index of the Herschel-Bulkley fluid rheology model; \dot{γ} is the shear rate; rᵢ is a distance where in-situ pore pressure of the rock may be encountered, wherein the distance may be established based on recommendations from logging and engineering teams; r_{w} is wellbore radius; and k is the consistency index of the Herschel-Bulkley fluid rheology model. While the preceding Equations 1 and 2 are based on the Herschel-Bulkley fluid rheology model, it should be understood that the loss circulation model for natural fractures is independent of the specific fluid model. For example, the loss circulation model may be used for fluids with shear-dependent viscosity which may be described by Newtonian, power law, Cross law, Carreau law, generalized Herschel Bulkley model, or generalized Newtonian fluid rheology models. These various models have different but similar mathematical functions that describe the fluid's shear stress vs shear rate response in viscometric geometries. Approaches may also be applied to thixotropic fluids and viscoelastic fluids.

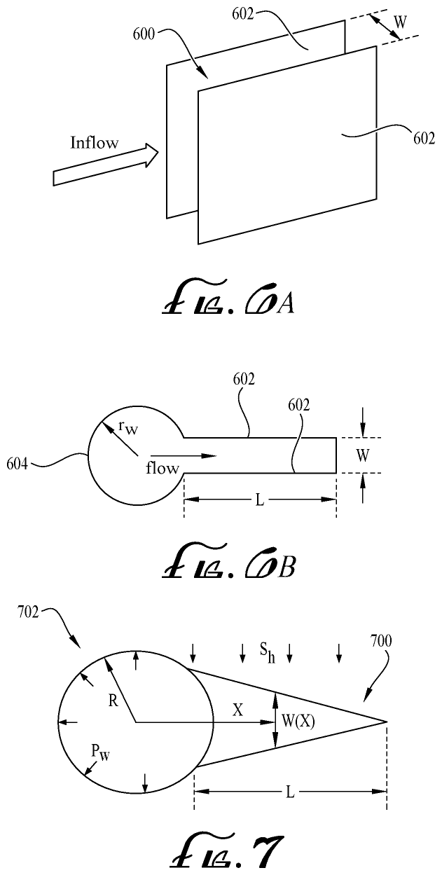

The formation fracture model 424 can also be used to determine if the loss rate is indicative of induced fractures. Any suitable geometry can be used to model the induced fractures, including, but not limited to: narrow slits; irregular fractures; groups of tubes; and the like. FIGS. 6A and 6B illustrate an assumed geometric shape for induced fractures. As illustrated, the induced fracture may be modeled as a slot 600 with parallel walls 602, wherein the width (w) is the distance between the parallel walls 602. The width (w) generally corresponds to the width of the fracture opening at the wellbore 604. The slot 600 may also be defined to have a length (L). As further illustrated, fluid will be lost from the wellbore 604, e.g., wellbore 6, into the slot 600. The wellbore 604 can be defined to have a radius (r_{w}).

Below is an example equation that may be used to determine if the loss rate (\dot{Q}) is indicative of induced fractures:

\dot{Q}=f(differential pressure,fracture characteristics,rheology) Equation 4

The following are additional example equations that may be used to model the loss rate (\dot{Q}) for induced fractures as a slot with parallel walls for fracture, e.g., fracture 334, covering a loss zone of length h along the wellbore 6:

$$\dot{Q} = ( \frac{{hw}^{2}}{2} ) {( \frac{{p}^{′} w}{2 k} )}^{\frac{1}{m}} \frac{m}{2 m + 1} {( 1 - {Z}_{p} )}^{\frac{m + 1}{m}} ( 1 + \frac{m}{m + 1} ) {Z}_{p} \qquad Equation 5$$

$$wherein {Z}_{p} = \frac{2 {τ}_{y}}{{p}^{′} w} \qquad Equation 6$$

$$wherein {p}^{′} = \frac{Δ P}{{r}_{i} - {r}_{w}} \qquad Equation 7$$

wherein h is length of fracture opening along the wellbore 6; w is the distance between parallel plates; p′ is pressure gradient in the fracture; m is the power law index of the Herschel-Bulkley fluid, Zₚ is dimensionless quantity; τ_{y} is the yield stress of the fluid; rᵢ is far end of the fracture where pressure is equal to the undisturbed pore pressure of the formation, e.g., formation 314; r_{w} is wellbore radius. The dimensionless quantity (Zₚ) can be calculated, for example, from the Herschel-Bulkley parameters, pressure gradient and fracture width (w). By virtue of induced fractures being symmetric along a minimum horizontal stress axis, this equation represents loss rate through one half of the loss zone. While the preceding Equations 4 to 7 are based on the Herschel-Bulkley fluid rheology model, it should be understood that the formation fracture model 424 for induced fractures is independent of the specific fluid model. For example, the formation fracture model 424 may be used for fluids with shear-dependent viscosity which may be described by Newtonian, power law, Cross law, Carreau law, generalized Herschel Bulkley model, or generalized Newtonian fluid rheology models. These various models have different but similar mathematical functions that describe the fluid's shear stress vs shear rate response in viscometric geometries. Approaches may also be applied to thixotropic fluids.

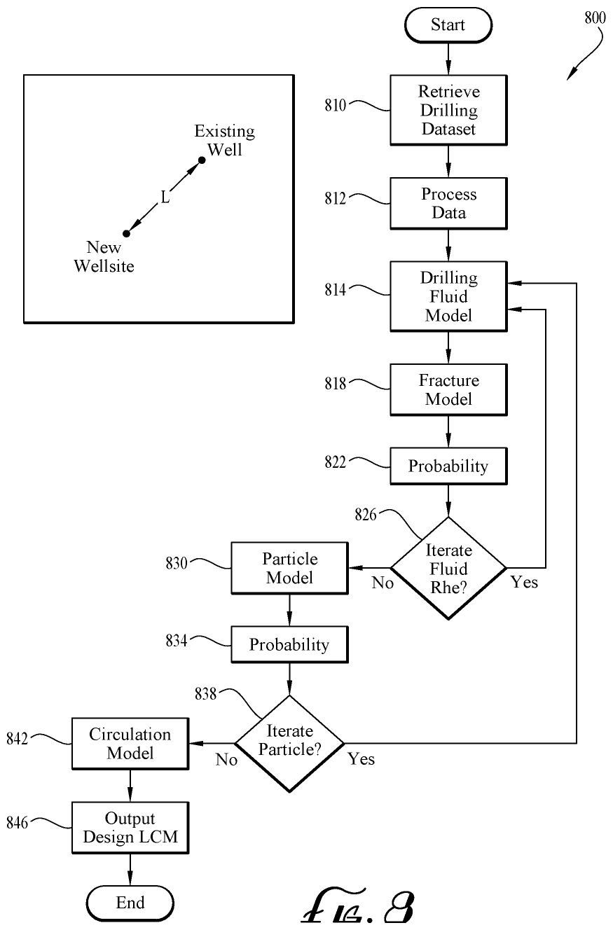

Alternatively, in some examples, the size of induced fractures may be governed by geo-mechanical equations connecting rock mechanical properties, circulation pressure, and rock in-situ stress. FIG. 7 is a schematic of an induced fracture in accordance with one or more embodiments. As illustrated, the fracture 700 may have a width of w(x) that is a function of the distance (x) from the center of the wellbore 702. As further illustrated, L is the length of the fracture 700 and R is the radius of the wellbore 702. FIG. 7 also shows the minimum horizontal stress in rock as Si, and the wellbore pressure as p_{w}. Below is an example equation that may be used in determining size of induced fractures, for example, with the model of FIG. 7:

$$w ( x ) = \frac{4 ( 1 - {v}^{2} )}{E} ( {p}_{w} - {S}_{h} ) \sqrt{{( L + R )}^{2} - {x}^{2}} \qquad Equation 8$$

wherein Sₕ is the minimum horizontal stress in rock; p_{w} is wellbore pressure; E is young's modulus of the formation rock; v is the Poisson's ratio of the formation rock; L=rᵢ−r_{w}, the length of the fracture; and R is the radius of the wellbore.

In some embodiments, the dimensions of the induced fracture may vary over time. For example, coupling geomechanics and hydraulics may result in a scenario wherein the characteristic dimensions of the induced fracture may depend on the state of the wellbore at any given time. In particular, width of the fracture depends on the pressure in the wellbore at the loss location which is a function of the fluids positions, their properties and flow rates for a given wellbore geometry.

In addition to natural and induced fractures, highly permeable zones are another fluid loss mechanism that may be included in the formation fracture model 424. Any suitable geometry can be used to model highly permeable zones. In general, in some embodiments, the loss rate for highly permeable fractures can be modelled as a function of pressure drop, rheology, geometric parameters of the well and the characteristic shape factors of loss zone as follows:

\dot{Q}=f(Δp,GHB parameters,r_{w},radial extent of loss zone,pore pressure) Equation 9

In some embodiments, highly permeable zones may be modeled as a stack of discs. For example, the width, ww, of each disc in the stack may be given by:

w=2\sqrt{3*K} Equation 10

wherein K is the permeability of the zone and w is the width of the disc. An unknown for this model of a stack of discs may be the number of discs in accordance with highly permeable zones, the unknown is the number of discs in the stack. It should be noted that the term disc may be used interchangeably with the word disc and likewise the plural of such. This number may be determined using operational data in wellbore hydraulics model 414, as disclosed herein. For example, the length of the highly permeable zone along the wellbore may be first be obtained such that the number, n, may be determined using n=(L/w), which might be converted to nearest integer. One of ordinary skill in the art should be able to estimate length of the highly permeable zone, for example, from depth at which losses occurred and changes of loss rate as drilling continued.

The above Equations 1-10 provide example equations that can be used for modelling the fracture geometry within the Formation Fracture model 424. With a known loss rate, from output values 416 of step 410, these equations may be used in the model 424, for example, to determine the geometry of the fracture and loss characteristics. However, these example calculations are only representative. It is possible to use other models which may have multiple fracture characteristics representing more complex geometries to represent all three loss mechanisms. For example, the case of natural fracture may be modeled as a network of pipes intersecting the wellbore. In that case, distribution of pipe diameters, e.g., mean diameter and standard deviation, and connectivity of pipes as fracture characteristics, which may be determined using appropriate loss data. Depending on valid, simplified geometries for different loss mechanisms, other equations connecting loss rate to inputs may be derived. The exact form of the equations for modelling depends, for example, on the nature of losses (e.g., natural vs. induced vs. permeable zones etc.), the assumed shape for loss zone, and the type of rheology model used to describe the fluid being lost. Some example forms could be polynomial, exponential, transcendental etc. Further, a data-driven machine learning model like Neural Networks can be used in place of an analytical form. In some embodiments, a machine learning model may be trained on the formation fracture model 424 to determine the fracture characteristics. The examples shown above are used to illustrates the workflow and thus some specific shapes of loss zone are used with their corresponding analytical forms for loss rate versus pressure drop.

Returning to FIG. 4, the formation fracture model 424 can determine the probability of the type of fracture and determine the geometry of the fracture by modeling the input values 422 with the mathematical models. The output values 426 of the formation fracture model 424 can include the type of fracture and geometry of the fracture.

At step 430, the input values 432 of the third model, e.g., model 434, can include the output values 426 of the second model, e.g., model 424. The design process 124 can transfer the output values 426 from the formation fracture model 424 to the particle model 434 as input values 432. The input values 432 may include the fracture type, the fracture geometry, an inventory of particles, a delivery fluid density and rheology, a concentration of particles, or combinations thereof. The particle model 434 can determine a probability of placement of the particle type within the throat of the fracture, also referred to as jamming the fracture, e.g., fracture 334 of formation 314, to form an interface along the surface and into the fracture. The particle model 434 can calculate the probability of placement of the particle type within the throat, e.g., jamming, based on a mathematical model of the relationship of particle size, particle geometry, and distribution along the fracture geometry depending on the type of fracture.

Below is an example equation that may be used to determine the probability of jamming for particle types:

$$Probability of jamming ∼ A {exp}^{( - α d )} \qquad Equation 11$$

$$wherein d = {( \frac{{d}_{o}}{{d}_{p}} )}^{2} - 1 \qquad Equation 12$$

The probability of jamming can be an approximation based on a dispersal of spherical particles. The variable A and a are constants which effectively capture the effect of concentration of particles in the slurry, e.g., carrier fluid, the density of the carrier fluid, and the rheology. The probability of jamming is also dependent on size of the particle and distribution of the particle to the geometry of the fracture. In an embodiment, the particle size and distribution may be extrapolated to non-spherical particles utilizing shape factors.

The particle model 434 can determine a filtration property, including porosity and/or permeability, of the interface formed along the surface and within the fracture by the placement of particle types within the fracture geometry. This interface, also referred to as filter cake, may be packing of particles within the fracture geometry and along the inner surface of the wellbore 6. When the particles fill and seal the fracture geometry, the porosity may be zero. In another scenario, the particles fill the fracture geometry and effectively choke or reduce the fluid loss rate. The particle model 434 can determine a porosity of the interface with two scenarios: an ideal distribution of a single particle size or a mixture of distributions of multiple particle sizes. In the first scenario, the single size of particle may be delivered to the fracture location. In the second scenario, the fracture location may receive a fluid loss treatment with multiple particles sizes.

Below is an example equation that may be used to determine the porosity of the interface, e.g., the filter cake with a single type of particle size distribution:

$$k = {φ}^{2} \frac{{ε}^{3} {D}^{2}}{150 {( 1 - ε )}^{2}} \qquad Equation 13$$

D represents a log based average particle diameter. ε represents an estimated porosity based on empirical results. φ represents the sphericity of the particles forming the interface.

Below is an example equation that may be used to determine the porosity of the interface, e.g., the filter cake with a multiple types of particle sizes and distribution of particles sizes:

$$\frac{1}{K} = \frac{{V}_{1}}{{K}_{1}} + \frac{{V}_{2}}{{K}_{2}} + … \qquad Equation 14$$

Vᵢ represents the volume fraction of a first particle and Kᵢ represents a modal function shown in Equation 13 for each particle size.

The above Equations 11-14 provide example equations that can be used for modelling a filter property of the interface including the porosity and permeability of the interface, e.g., filter cake, within the particle model 434. With a known fracture geometry, from output values 426 of step 420, these equations may be used in the model 434, for example, to determine the probability of jamming along the geometry of the fracture and the resultant permeability characteristics. However, these example calculations are only representative. It is possible to use other models which may have multiple jamming characteristics along more complex geometries or combined geometries of all three fracture types.

The output 436 of the particle model 434 may include an estimated porosity and permeability of the interface at the fracture location for a single particle. The output 436 may include an estimated porosity and permeability of the interface for the inventory of particles provided as an input values 432 in step 430. The output 436 of the particle model 434 may provide a recommended particle from the inventory of particles available at the wellsite.

At step 440, the design process 124 of FIG. 2 can deliver the output 436 of the third model 434, e.g., the particle model, for verification in the form of lab testing. The estimated porosity and permeability of the particle size and distribution recommended for the fracture geometry determined in the second model 424 based on the fluid loss mechanism identified by the first model 414 can be submitted for laboratory testing. A sample of the fluid loss control treatment can be generated. The sample may be submitted for laboratory testing for a plurality of properties such as rheological behavior, stability under wellbore temperature and pressure conditions, filtration properties including characterization of filter cake, or combinations thereof. The characterization of the filter cake, e.g., deposited particles, may include the thickness of the deposited particles, the resultant permeability of the fracture, and composition of the filter cake. The results of the laboratory testing may be used as inputs into the method 400. For example, the variables for the particle model, e.g., concentration of particles, may be modified based on the results of the laboratory testing. The results of the laboratory testing may verify the output 436 of the particle model 434. The output 436, the particle size and concentration, may provide a fluid loss control treatment for the low pressure zone, e.g., fracture 334 in formation 314, encountered in the wellbore 6.

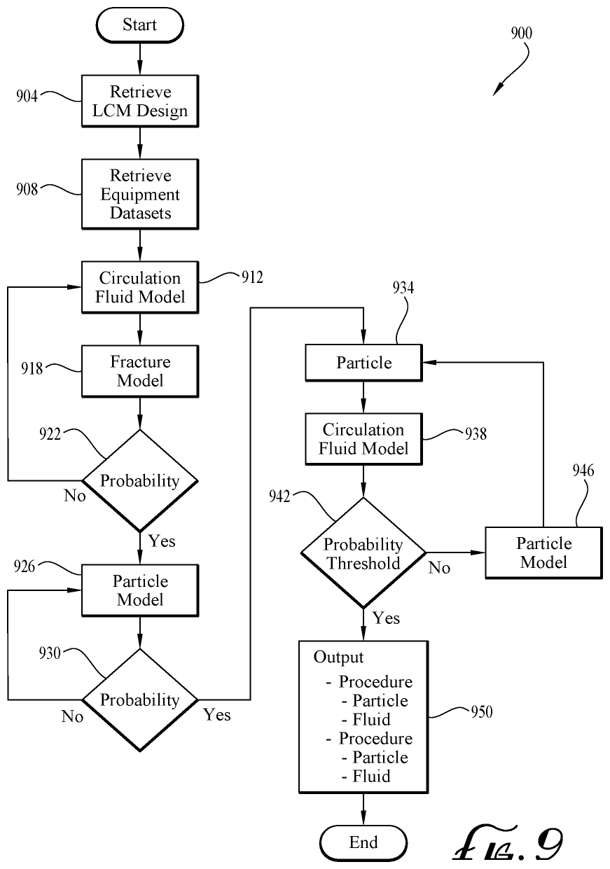

A fluid loss event may be anticipated from a historical database of existing wellsites. At least one fluid loss control treatments can be designed based the drilling dataset from one or more offset wells within the same field. A request may be received from a customer device 136 for a fluid loss control treatment for a new wellsite within the same field as at least one offset wellsite. Turning now to FIG. 8, a method 800 of designing a fluid loss control treatment from offset well data is illustrated as a logic block diagram. The design process 124 of FIG. 3 may utilize at least one model 126 to generate a fluid loss control treatment for a known low pressure zone, e.g., fracture 336 of FIG. 3. At step 810, the design process 124 may retrieve a drilling dataset of an offset well from a historical database 128 located on storage computer 114. As previously described, the drilling dataset may include the daily drilling log, the mud log, the mud logging report, a sensor dataset from the fluid system, the lifting mechanism, the rotation mechanism, the wellhead, the BHA 10, or combinations thereof. The design process 124 may retrieve the drilling dataset from the historical database 128, the storage computer 114, the communication device 118, the remote wellsite 116, the customer device 136, the computer system 122, a virtual computer within the 5G network, or combinations thereof.

At step 812, the design process 124 may process the data from the drilling datasets. The data processing may include transformation of mud-pulse data into sensor data measurements. The data processing may include the generation of a wellbore path and trajectory based on distance measured along the axis of the wellbore 6. The drilling dataset may comprise drilling equipment datasets, datasets from BHA 10, and mud system datasets. The drilling equipment datasets can include periodic datasets of pressure, flowrate, torque, hook load and rpm. The dataset from the BHA 10 can include periodic datasets from an MWD and/or LWD drilling system comprising temperature, pressure, fracture gradient, pore pressure, loss data, lithology, formation porosity, formation permeability, and trajectory. The mud system dataset can include a mud report and periodic datasets of circulation pressure, density, rheology, fluid loss, chemical properties, and solids control.

At step 814, the design process 124 may input the mud system dataset into a drilling fluid model 814. The drilling fluid model 814 may be the wellbore hydraulics model 414 of method 400. The drilling fluid model 814 may utilize the geometry of the drill string 12 and the wellbore 6 to determine the annular volume and fluid flowrates. As previously described, the drilling fluid model 814 can determine a fluid loss mechanism, a fluid loss rate, a fluid rheology, a wellbore geometry and trajectory, formation properties, or combinations thereof for at least one low pressure zone, e.g., formation 314, within a wellbore of an offsetting wellsite.

At step 818, the design process 124 may input the fluid loss rate and fluid loss mechanism into a fracture model 818. The fracture model 818 may be the formation fracture model 424 of method 400. The fracture model 818 can determine a probability of the fracture, e.g., fracture 336 of formation 316, being one of three types of fractures: a natural fracture, an induced fracture, or a highly permeable zone. The formation fracture model 818 can calculate the loss rate based on mathematical models of each type of fracture and generate a probability of the fluid loss rate being a resultant of each type of fracture.

At step 822, the design process 124 can determine the fracture geometry with the greatest probability by comparing the results of the mathematical models. In some embodiments, the design process 124 may compare the results of the fracture model with first fluid density and rheology to the results of the fracture model with a second fluid density and rheology.

At step 826, the design process 124 can determine if the offset well iterated the drilling fluid density, rheology, material properties, or combinations thereof. For example, the drilling operation may have modified the density of the drilling fluids during the drilling operation. In another scenario, the drilling operation may have pumped an fluid loss control treatment into a low pressure zone. The design process may return to step 814 each time the drilling fluid density and/or rheology is modified.

At step 830, the design process 124 may input the type and geometry of the fracture of the low pressure zone determined in the fracture model 818 to a particle model 830. As previously described, the particle model 830 can generate a predicted filtration property including the porosity and/or permeability of the interface formed along the fracture geometry of the low pressure zone. In some embodiments, the particle type may be selected from an inventory of available particle types.

At step 834, the design process 124 can determine the particle with the greatest probability of generating the desired porosity and permeability by comparing the results of the mathematical models of the particle model 830. In some embodiments, the design process 124 may compare the results of the particle model 830 with first particle applied to the fracture to the results of the particle model 830 with a second particle applied to the fracture.

In some embodiments, one of the inputs into the particle model 830 may be a job objective. A job objective may include limiting a volume of drilling fluid lost, limiting a rate of drilling fluid lost, zonal isolation, e.g., cement barrier, a placement of cement, e.g., top of cement (TOC), or combinations thereof. A job objective that includes zonal isolation may include a pressure test of the cement barrier at the float shoe also referred to as a shoe test. The shoe test may include a Leak off Test (LOT) or a Formation Integrity Test (FIT). The job objective can be provided by the customer, the service company, or an industry standard. The threshold values for porosity, permeability, or combinations thereof within the particle model 830 can be determined by the job objective. For example, the job objective of the placement of cement (e.g., TOC) may include a higher threshold for fluid loss than limiting a volume of drilling fluid loss. The threshold values for the particle model can allow for a rate of fluid loss while achieving the job objective.

At step 838, the design process 124 can determine if the first particle selected will generate the permeability and porosity at the fracture location exceeds the threshold value. If the first particle fails to achieve the threshold value, the particle may be iterated, as in, a second particle may be selected. The design process 124 may return to step 814 with the second particle selected.

At step 814, the drilling fluid model 814 may utilize the predicted porosity and permeability, from step 838, to predict a second fluid loss rate.

At step 818, the design process 124 can determine a second fracture geometry based on inputting the second fluid loss rate into the fracture model 818.

At step 830, the design process 124 can determine a second particle based on the modified porosity and permeability of the fracture of the low pressure zone from the first particle. The design process 124 may determine a second particle from an inventory of particles available at the wellsite.

At step 842, the design process 124 can input the particle into a circulation model to determine the fluid properties of the carrier fluid. For example, the carrier fluid density, rheology, and/or material properties to convey the particle to the fracture within the low pressure zone. The circulation model 842 may generate one or more volumes of fluid for transportation of the particles. For example, a first volume of fluid may be a spacer fluid and a second volume of fluid may be a carrier fluid. The circulation model 842 may determine the pumping rates for each volume of fluid. The output of the circulation model 842 may include a pumping procedure for at least one pumping unit.

At step 846, the design process 124 may output a design of a fluid loss treatment based on offset well data. The design may include at least one particle, at least one volume of carrier fluid, a pumping procedure, or combinations thereof. In some embodiments, the design of the fluid loss treatment may include at least two particles.

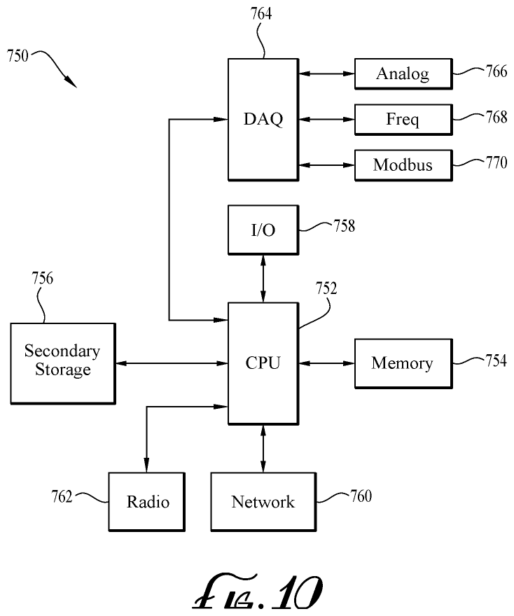

A wellbore servicing operation can comprise a pumping unit configured to perform a servicing operation on the wellbore 6 at a remote wellsite 116 as shown in FIG. 2. A wellbore servicing operation comprising a pumping unit, a fluid loss treatment design, and an inventory of fluid loss materials can be transported to a remote wellsite. The pumping unit may be fluidically connected to the wellbore via the wellhead. Turning now to FIG. 9, a method 900 of designing a fluid loss control treatment during wellbore servicing operation is illustrated as a logic block diagram. The design process 124 may be executing on a unit controller of the pumping unit. The unit controller may comprise a processor and non-transitory memory. The design process 124 may utilize at least one model 126 to generate a fluid loss control treatment.

At step 904, the design process 124 may retrieve a LCM design from a storage location. The LCM design may be the fluid loss treatment generated at step 846 of method 800 as shown on FIG. 8. The storage location may be located on the pumping unit, within the control unit of the pumping unit, a computer system 122, a storage computer 144, a historical database 128, a virtual computer on the 5G network, or combinations thereof.

At step 908, the design process 124 may retrieve equipment datasets indicative of the wellbore servicing operation. The equipment datasets may be periodic dataset from equipment sensors such as pressure transducers, flowrate sensors, positional sensors, valve position sensors, or combinations thereof. The design process 124 may process the data from the equipment datasets. The data processing may include transformation of sensor data measurements into data values. The data processing may include the generation of a wellbore path and trajectory based on distance measured along the axis of the wellbore 6. The equipment dataset can include fluid system datasets comprising periodic datasets of circulation pressure, density, rheology, fluid loss, chemical properties, and solids control.

At step 912, the design process 124 may input the equipment datasets into a circulation fluid model 912. The circulation fluid model 912 may be the wellbore hydraulics model 414 of method 400. The circulation fluid model 912 may utilize the geometry of a casing string, primary cementing equipment (for example a float shoe) and the wellbore 6 to determine the annular volume and annular fluid flowrates. As previously described, the circulation fluid model 912 can determine a fluid loss mechanism, a fluid loss rate, a fluid rheology, a wellbore geometry and trajectory, formation properties, or combinations thereof for at least one low pressure zone, e.g., formation 316, within a wellbore, e.g., wellbore 6.

At step 918, the design process 124 may input the fluid loss rate and fluid loss mechanism into a fracture model 918. The fracture model 918 may be the formation fracture model 424 of method 400. The fracture model 918 can determine a probability of the fracture, e.g., fracture 336 of formation 316, being one of three types of fractures: a natural fracture, an induced fracture, or a highly permeable zone. The formation fracture model 918 can calculate the loss rate based on mathematical models of each type of fracture and generate a probability of the fluid loss rate being a resultant of each type of fracture.

At step 922, the design process 124 can determine the fracture geometry with the greatest probability of matching the fluid loss rate by comparing the results of the mathematical models. The design process 124 may recommend pumping a wellbore treatment, a drilling fluid, a spacer fluid, or combinations thereof with a varied density and/or rheology to the low pressure zone, e.g., fracture 336 in formation 316, to generate a second fluid loss rate within the fracture 336. The wellbore fluid, e.g., wellbore treatment, with the second density and rheology can generate a second probability of fracture geometry within the fracture model 918. In some embodiments, the design process 124 may compare the results of the fracture model 918 with first fluid density and rheology to the results of the fracture model 918 with a second fluid density and rheology to determine increase the probability of the fracture geometry results from the fracture model 918. The design process 124 may return to step 912 with the second fluid treatment to determine a fluid loss rate input for the fracture model 918.

At step 926, the design process 124 may input the fracture type and fracture geometry of the low pressure zone determined in the fracture model 918 into a particle model 926. As previously described, the particle model 926 can generate a predicted filtration property including the porosity and/or permeability of the interface formed along the fracture geometry of the low pressure zone. In some embodiments, the particle type may be selected from an inventory of available particle types transported to the wellsite.

At step 930, the design process 124 can determine the particle type with the greatest probability of generating the desired porosity and permeability by comparing the results of the mathematical models of the particle model 926. In some embodiments, the design process 124 may compare the results of the particle model 926 with first particle type applied to the fracture to the results of the particle model 926 with a second particle applied to the fracture. The design process 124 can determine if the first particle selected from an inventory of particles will generate the permeability and porosity at the fracture location above a threshold value. If the first particle type fails to achieve the threshold value, the particle may be iterated, as in, a second particle from the inventory of particle types may be selected and the porosity and permeability compared to the threshold. The design process 124 may iterate through all of the particle types within the inventory of particle types to determine the greatest probability of exceeding the threshold value.

At step 934, the design process 124 may designate a design particle from the inventory of particles.

At step 938, the design process 124 may input the particle into the circulation fluid model 938 to determine the fluid properties of the carrier fluid. For example, circulation fluid model 938 may determine the carrier fluid density, rheology, and/or material properties to convey the design particle (step 934) at the desired concentration to the fracture, e.g., fracture 336, within the low pressure zone. The circulation model 938 may generate one or more volumes of fluid for transportation of the particles. For example, a first volume of fluid may be a spacer fluid and a second volume of fluid may be a carrier fluid. The circulation model 938 may determine the pumping rates for each volume of fluid. The output of the circulation model 938 may include a pumping procedure for at least one pumping unit.

At step 942, the design process 124 may determine the probability of exceeding a threshold value for the fracture porosity and permeability for the design particle (step 934) and the carrier fluid (step 938). The design process 124 may determine a modified fracture geometry with the design particle and carrier fluid rheology as an input into the fracture model 918. The design process 124 may determine a modified fracture porosity and permeability from the particle model 926 with the modified fracture geometry as an input. If the modified fracture porosity and permeability does not exceed a threshold value, the design process may step to block 946.

The design process 124 may iterate the particle type with the particle model 926. The design process 124 may select a second particle type from the inventory of available particle types by selecting the particle type with the predicted porosity and permeability closest to the threshold value. The design process 124 may return to step 934 with the iterated particle.

If the design particle and carrier fluid exceeds the threshold value for the fracture porosity and permeability, the design process steps to block 950. The design process 124 may output a design of a fluid loss treatment based on particle design during wellbore operations. The design may include at least one particle, at least one volume of carrier fluid, a pumping procedure, or combinations thereof. In some embodiments, the design of the fluid loss treatment may include at least two particles.

The unit controller may be a computer system suitable for communication and control of the drilling equipment. In FIG. 1, the unit controller 42 may establish control of the operation of the drilling system, the fluid system, and the communication device 28. In some embodiments, the unit controller 42 may be an exemplary computer system 750 described in FIG. 10. Turning now to FIG. 10, a computer system 750 suitable for implementing one or more embodiments of the unit controller, for example 42, including without limitation any aspect of the computing system associated with the drilling system of FIG. 1 and the remote wellsite 116 of FIG. 2 and the pumping equipment 634 of FIG. 6 and any aspect of a unit control as shown as unit controller 48 in FIG. 1. The computer system 750 may be suitable for implementing one or more embodiments of the computer system in FIG. 2, for example computer system 122, storage computer 114, user devices 130, and customer device 136. The computer system 750 includes one or more processors 752 (which may be referred to as a central processor unit or CPU) that is in communication with memory 754, secondary storage 756, input output devices 758, DAQ card 764, and network devices 760. The computer system 750 may continuously monitor the state of the input devices and change the state of the output devices based on a plurality of programmed instructions. The programming instructions may comprise one or more applications retrieved from memory 754 for executing by the processor 752 in non-transitory memory within memory 754. The input output devices may comprise a Human Machine Interface with a display screen and the ability to receive conventional inputs from the service personnel such as push button, touch screen, keyboard, mouse, or any other such device or element that a service personnel may utilize to input a command to the computer system 750. The secondary storage 756 may comprise a solid state memory, a hard drive, or any other type of memory suitable for data storage. The secondary storage 756 may comprise removable memory storage devices such as solid state memory or removable memory media such as magnetic media and optical media, i.e., CD disks. The computer system 750 can communicate with various networks with the network devices 760 comprising wired networks, e.g., Ethernet or fiber optic communication, and short range wireless networks such as Wi-Fi (i.e., IEEE 802.11), Bluetooth, or other low power wireless signals such as ZigBee, Z-Wave, 6LoWPan, Thread, and WiFi-ah. The computer system 750 may include a long range radio transceiver 762 for communicating with mobile network providers.

The computer system 750 may comprise a DAQ card 764 for communication with one or more sensors. The DAQ card 764 may be a standalone system with a microprocessor, memory, and one or more applications executing in memory. The DAQ card 764, as illustrated, may be a card or a device within the computer system 750. In some embodiments, the DAQ card 764 may be combined with the input output device 758. The DAQ card 764 may receive one or more analog inputs 766, one or more frequency inputs 768, and one or more Modbus inputs 770. For example, the analog input 766 may include a volume sensor, e.g., a tank level sensor. For example, the frequency input 768 may include a flow meter, i.e., a fluid system flowrate sensor. For example, the Modbus input 770 may include a pressure transducer. The DAQ card 764 may convert the signals received via the analog input 766, the frequency input 768, and the Modbus input 770 into the corresponding sensor data. For example, the DAQ card 764 may convert a frequency input 768 from the flowrate sensor into flow rate data measured in gallons per minute (GPM).

The systems and methods disclosed herein may be advantageously employed in the context of wellbore servicing operations, particularly, in relation to the design of a fluid loss treatment for a wellbore servicing operation as disclosed herein.

In some embodiments, a design process may retrieve a drilling dataset indicative of a drilling operation from a historical database. The design process may generate a periodic dataset from the fluid system within the drilling dataset. The design process may determine a fluid loss rate to a low pressure zone of the wellbore by inputting the periodic dataset into a hydraulic fluid model. The design process may determine a fracture type and fracture geometry by inputting the fluid loss rate from the first model into a fracture model. The design process may determine a particle type from an inventory of particles to generate a desired porosity and permeability by inputting the fracture type and fracture geometry into a particle model. The design process may design a fluid loss treatment comprising a particle type and a carrier fluid for at least one low pressure zone within a wellbore. A validation process may include laboratory testing. The design process may output a fluid loss treatment comprising a particle type, a volume of carrier fluid, and a pumping procedure for each fracture within a low pressure zone.

Additionally or alternatively, the design process can receive real-time pumping datasets indicative of a wellbore servicing operation. The design process may determine a fluid loss rate by inputting real-time periodic datasets into a hydraulic fluid model. The design process may determine a fracture type and fracture geometry by inputting the fluid loss rate from the first model into a formation fracture model. The design process may design or revise a design of a fluid loss treatment by inputting the fracture type and fracture geometry from the second model into a particle model. The particle model may output a particle type and particle concentration for achieving the desired porosity and permeability at the fracture within the low pressure zone of the wellbore. The design process may output an fluid loss treatment comprising a particle type and particle concentration, a carrier fluid, a fluid volume, and a pumping procedure for at least one fracture within a low pressure zone.

### Additional Disclosure

The following are non-limiting, specific embodiments in accordance and with the present disclosure:

A first embodiment, which is a computer-implemented method of designing a wellbore fluid treatment, comprising: retrieving, by a design process executing on a processor, at least one dataset of a servicing operation at a wellbore; determining, by the design process, a fluid loss rate from the at least one dataset; determining, by the design process, a fracture location within a low pressure zone within the wellbore; determining, by a particle model, a particle type to form an interface with a filter property at the fracture location, wherein a fracture geometry is an input into the particle model, wherein the filter property achieves an operational objective, and wherein the filter property is a porosity value, a permeability value, or combinations thereof; and generating, by the design process, a fluid loss control treatment comprising a quantity of the particle type to form the interface for the fracture geometry within the wellbore.

A second embodiment, which is the method of the first embodiment, further comprising: determining, by a wellbore hydraulics model, the fluid loss rate by inputting the at least one dataset into the wellbore hydraulics model.

A third embodiment, which is the method of the first embodiment or second embodiment, further comprising: determining, by a formation fracture model, a fracture type, the fracture geometry, or combinations thereof by inputting the fluid loss rate, the at least one dataset, or combinations thereof into the formation fracture model.

A fourth embodiment, which is the method of the third embodiment, wherein the formation fracture model calculates a fracture as one of a group selected from a natural fracture, an induced fracture, or a highly permeable zone.

A fifth embodiment, which is the method of the first embodiment through the fourth embodiment, further comprising: designing, by the design process, a pumping procedure for the fluid loss control treatment, wherein the pumping procedure includes a volume and a flow rate of a carrier fluid.

A sixth embodiment, which is the method of the first embodiment, wherein the at least one dataset comprises a dataset selected from the group consisting of a fluid system dataset, a mud system dataset, a daily drilling report, a mud log, or combination thereof.

A seventh embodiment, which is the method of the first embodiment, wherein the particle model utilizes an equation for determining a probability of placement of the particle type within a throat of a fracture in the form:

Probability of jamming·A exp^{(-αd)}

wherein

$$d = {( \frac{{d}_{o}}{{d}_{p}} )}^{2} - 1 ;$$

A is a constant of the model; and α is a constant of the model.

An eighth embodiment, which is the method of the first embodiment wherein the particle model utilizes an equation for determining the porosity value of the interface:

$$k = {φ}^{2} \frac{{ε}^{3} {D}^{2}}{150 {( 1 - ε )}^{2}}$$

wherein D represents an average particle diameter; ε represents an estimated porosity based on empirical results; and φ represents a sphericity of the particle type forming the interface.

A ninth embodiment, which is the method of the first embodiment, further comprising: generating a sample of the fluid loss control treatment for at least one fracture; testing, by a laboratory test, a plurality of filtration properties of the fluid loss control treatment; and validating, by the laboratory test, the fluid loss control treatment in response to the filtration properties exceeding a threshold value.

A tenth embodiment, which is the method of the first embodiment, further comprising: transporting a fluid loss control treatment design and a pumping equipment to a well site, wherein the fluid loss control treatment design comprises an inventory of particle types, a carrier fluid, a pumping procedure, or combinations thereof; mixing a fluid loss control treatment, by the pumping equipment, per the pumping procedure; and pumping the fluid loss control treatment per the pumping procedure.

An eleventh embodiment, which is the method of the tenth embodiment, wherein the inventory of particle types comprise quantities of at least two particle types.

A twelfth embodiment, which is a computer-implemented method of designing a fluid loss control treatment with real-time pumping data, comprising: receiving, by a design process executing on a processor, at least one real-time dataset associated with a pumping equipment fluidically connected to a wellbore, wherein the at least one real-time dataset comprises a dataset selected from the group consisting of drilling equipment dataset, bottom hole assembly (BHA) dataset, fluid system dataset, or combination thereof; determining, by the processor, a fluid loss rate from the at least one real-time dataset; determining, by the processor, a low pressure zone within the wellbore; determining, by a particle model, a fluid loss control treatment comprising a quantity of a particle type and a volume of carrier fluid for forming an interface at a fracture location within a low pressure zone; and generating, by the design process, a fluid loss control treatment for the low pressure zone, wherein a filtration property of the fluid loss control treatment exceeds a threshold value, and wherein the filtration property is a porosity of the interface.

A thirteenth embodiment, which is the method of the twelfth embodiment, further comprising: processing the at least one real-time dataset to generate a periodic dataset.

A fourteenth embodiment, which is the method of twelfth embodiment or thirteenth embodiment, further comprising determining, by a wellbore hydraulics model, the fluid loss rate by inputting the at least one dataset into the wellbore hydraulics model.

A fifteenth embodiment, which is the method of the twelfth embodiment through fourteenth embodiment, further comprising determining, by a formation fracture model, a fracture type, a fracture geometry, or combinations thereof by inputting the fluid loss rate, the at least one dataset, or combinations thereof into the formation fracture model.

A sixteenth embodiment, which is the method of the fifteenth embodiment, wherein the fracture model calculates a fracture as one of a group selected from a natural fracture, an induced fracture, or a highly permeable zone.

A seventeenth embodiment, which is the method of the twelfth embodiment, further comprising: transporting an fluid loss control treatment design and a pumping equipment to a well site, wherein the fluid loss control treatment design comprises an inventory of particle types, a carrier fluid, a pumping procedure, or combinations thereof; mixing a fluid loss control treatment, by the pumping equipment, per the pumping procedure; and pumping the fluid loss control treatment per the pumping procedure.

An eighteenth embodiment, which is the method of the seventeenth embodiment, wherein the inventory comprises quantities of at least two particle types.

A nineteenth embodiment, which is a computer-implemented method of designing a fluid loss control treatment, comprising: retrieving, by a design process executing on a computer system, a drilling dataset for at least one offset well proximate to a new wellsite, and wherein the computer system comprises a non-transitory memory and a processor; determining, by a hydraulic fluid model, a fluid loss rate by inputting the drilling dataset into the hydraulic fluid model; determining, by a formation fracture model, a probability of a fracture type, a fracture geometry, or combinations thereof by inputting the fluid loss rate, the drilling dataset, or combinations thereof into the formation fracture model; determining, by a particle model, a particle type to form an interface in response to the fracture type or the fracture geometry, wherein the fracture type, the fracture geometry, the drilling dataset, or combinations thereof are inputs into the particle model; and designing, by the design process, a fluid loss control treatment comprising a quantity of particles and a volume of carrier fluid for forming an interface at a fracture location within a wellbore of the new wellsite.

A twentieth embodiment, which is the method of the nineteenth embodiment, further comprising: transporting a well servicing operation comprising a pumping equipment to the new wellsite, wherein the pumping equipment includes a unit controller, and wherein the unit controller comprises a processor and memory; transporting a fluid loss control treatment comprising an inventory of fluid loss control material to the new wellsite, and wherein the inventory includes at least two supplies of fluid loss control materials; receiving, by the unit controller, a design for the fluid loss control treatment, wherein the design comprises at least one of the supplies of fluid loss control materials and a pumping procedure; connecting the pumping equipment to the wellbore, wherein the pumping equipment is fluidically connected to the wellbore; mixing a fluid loss control treatment, by the unit controller, per the pumping procedure; and pumping the fluid loss control treatment per the pumping procedure.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of designing a wellbore fluid treatment, comprising:
retrieving, by a design process executing on a processor, at least one dataset of a servicing operation at a wellbore;
determining, by the design process, a fluid loss rate from the at least one dataset;
determining, by the design process, a fracture location within a low pressure zone within the wellbore;
determining, by a particle model, a particle type to form an interface with a filter property at the fracture location, wherein a fracture geometry is an input into the particle model, wherein the filter property achieves an operational objective, and wherein the filter property is a porosity value, a permeability value, or combinations thereof; and
generating, by the design process, a fluid loss control treatment comprising a quantity of the particle type to form the interface for the fracture geometry within the wellbore.

2. The method of claim 1, further comprising:
determining, by a wellbore hydraulics model, the fluid loss rate by inputting the at least one dataset into the wellbore hydraulics model.

3. The method of claim 1, further comprising:
determining, by a formation fracture model, a fracture type, the fracture geometry, or combinations thereof by inputting the fluid loss rate, the at least one dataset, or combinations thereof into the formation fracture model.

4. The method of claim 3, wherein the formation fracture model calculates a fracture as one of a group selected from a natural fracture, an induced fracture, or a highly permeable zone.

5. The method of claim 1, further comprising:
designing, by the design process, a pumping procedure for the fluid loss control treatment, wherein the pumping procedure includes a volume and a flow rate of a carrier fluid.

6. The method of claim 1, wherein the at least one dataset comprises a dataset selected from the group consisting of a fluid system dataset, a mud system dataset, a daily drilling report, a mud log, or combination thereof.

7. The method of claim 1, wherein the particle model utilizes an equation for determining a probability of placement of the particle type within a throat of a fracture in the form:
Probability of jamming˜A exp^{(-αd)}
wherein
$$d = {( \frac{{d}_{o}}{{d}_{p}} )}^{2} - 1 ;$$
A is a constant of the model; and α is a constant of the model.

8. The method of claim 1, wherein the particle model utilizes an equation for determining the porosity value of the interface:
$$k = {φ}^{2} \frac{{ε}^{3} {D}^{2}}{150 {( 1 - ε )}^{2}}$$
wherein D represents an average particle diameter; ε represents an estimated porosity based on empirical results; and φ represents a sphericity of the particle type forming the interface.

9. The method of claim 1, further comprising:
generating a sample of the fluid loss control treatment for at least one fracture;
testing, by a laboratory test, a plurality of filtration properties of the fluid loss control treatment; and
validating, by the laboratory test, the fluid loss control treatment in response to the filtration properties exceeding a threshold value.

10. The method of claim 1, further comprising:
transporting a fluid loss control treatment design and a pumping equipment to a well site, wherein the fluid loss control treatment design comprises an inventory of particle types, a carrier fluid, a pumping procedure, or combinations thereof;
mixing a fluid loss control treatment, by the pumping equipment, per the pumping procedure; and
pumping the fluid loss control treatment per the pumping procedure.

11. The method of claim 10, wherein the inventory of particle types comprise quantities of at least two particle types.

12. A computer-implemented method of designing a fluid loss control treatment with real-time pumping data, comprising:
receiving, by a design process executing on a processor, at least one real-time dataset associated with a pumping equipment fluidically connected to a wellbore, wherein the at least one real-time dataset comprises a dataset selected from the group consisting of drilling equipment dataset, bottom hole assembly (BHA) dataset, fluid system dataset, or combination thereof;
determining, by the processor, a fluid loss rate from the at least one real-time dataset;
determining, by the processor, a low pressure zone within the wellbore;
determining, by a particle model, a fluid loss control treatment comprising a quantity of a particle type and a volume of carrier fluid for forming an interface at a fracture location within a low pressure zone; and
generating, by the design process, a fluid loss control treatment for the low pressure zone, wherein a filtration property of the fluid loss control treatment exceeds a threshold value, and wherein the filtration property is a porosity of the interface.

13. The method of claim 12, further comprising:
processing the at least one real-time dataset to generate a periodic dataset.

14. The method of claim 12, further comprising:
determining, by a wellbore hydraulics model, the fluid loss rate by inputting the at least one dataset into the wellbore hydraulics model.

15. The method of claim 12, further comprising:
determining, by a formation fracture model, a fracture type, a fracture geometry, or combinations thereof by inputting the fluid loss rate, the at least one dataset, or combinations thereof into the formation fracture model.

16. The method of claim 15, wherein the fracture model calculates a fracture as one of a group selected from a natural fracture, an induced fracture, or a highly permeable zone.

17. The method of claim 12, further comprising:
transporting an fluid loss control treatment design and a pumping equipment to a well site, wherein the fluid loss control treatment design comprises an inventory of particle types, a carrier fluid, a pumping procedure, or combinations thereof;
mixing a fluid loss control treatment, by the pumping equipment, per the pumping procedure; and
pumping the fluid loss control treatment per the pumping procedure.

18. The method of claim 17, wherein the inventory comprises quantities of at least two particle types.

19. A computer-implemented method of designing a fluid loss control treatment, comprising:
retrieving, by a design process executing on a computer system, a drilling dataset for at least one offset well proximate to a new wellsite, and wherein the computer system comprises a non-transitory memory and a processor;
determining, by a hydraulic fluid model, a fluid loss rate by inputting the drilling dataset into the hydraulic fluid model;
determining, by a formation fracture model, a probability of a fracture type, a fracture geometry, or combinations thereof by inputting the fluid loss rate, the drilling dataset, or combinations thereof into the formation fracture model;
determining, by a particle model, a particle type to form an interface in response to the fracture type or the fracture geometry, wherein the fracture type, the fracture geometry, the drilling dataset, or combinations thereof are inputs into the particle model; and
designing, by the design process, a fluid loss control treatment comprising a quantity of particles and a volume of carrier fluid for forming an interface at a fracture location within a wellbore of the new wellsite.

20. The method of claim 19, further comprising:
transporting a well servicing operation comprising a pumping equipment to the new wellsite, wherein the pumping equipment includes a unit controller, and wherein the unit controller comprises a processor and memory;
transporting a fluid loss control treatment comprising an inventory of fluid loss control material to the new wellsite, and wherein the inventory includes at least two supplies of fluid loss control materials;
receiving, by the unit controller, a design for the fluid loss control treatment, wherein the design comprises at least one of the supplies of fluid loss control materials and a pumping procedure;
connecting the pumping equipment to the wellbore, wherein the pumping equipment is fluidically connected to the wellbore;
mixing a fluid loss control treatment, by the unit controller, per the pumping procedure; and
pumping the fluid loss control treatment per the pumping procedure.
